(19) United States
(12) Patent Application Publication
(10) Pub. No.: US 2009/0170591 A1
(43) Pub. Date: Jul. 2, 2009

(54) GAMING SYSTEM AND A METHOD OF GAMING

(75) Inventor: Colin Fong, Penshurst (AU)

Correspondence Address: MCANDREWS HELD & MALLOY, LTD, 500 WEST MADISON STREET, SUITE 3400, CHICAGO, IL, 60661, US

(73) Assignee: ARISTOCRAT TECHNOLOGIES AUSTRALIA PTY LIMITED, Lane Cove, NSW (AU)

(21) Appl. No.: 12/200,690

(22) Filed: Aug. 28, 2008

(30) Foreign Application Priority Data
Aug. 29, 2007 (AU) 2007904695

(51) Int. Cl. A63F 9/24; A63F 13/00

(52) U.S. Cl. 463/20; 463/31

(57) ABSTRACT

A gaming system (10, 40, 100) is disclosed which comprises a display device (44) arranged to display symbols (306, 308) from a plurality of sets of symbols (15a, 15b) at a plurality of display positions (304), each of the display positions (304) including a symbol associated with each of the sets of symbols (15a, 15b). The system also comprises a symbol set selector (24) arranged to facilitate selection by a player of one of the sets of symbols to be used for determining a game outcome, a symbol selector (20) arranged to select symbols for display at the display positions, and an outcome generator (28) arranged to determine a game outcome based on symbols from the selected symbol set displayed at the display positions. A corresponding method is also disclosed.

### RELATED APPLICATIONS

The present application is a non-provisional application, which claims priority to Australian Provisional Patent Application No. 2007904695 filed Aug. 29, 2007, which is incorporated herein by reference in its entirety.

### BACKGROUND OF THE INVENTION

1. Field of the Invention

The present invention relates to a gaming system and to a method of gaming.

2. Background of the Invention

It is known to provide a gaming system which comprises a game controller arranged to randomly display several symbols from a predetermined set of symbols and to determine a game outcome such as a game win based on the displayed symbols. Such gaming systems may commonly be implemented as a stepper machine provided with reels with each reel carrying several symbols of the set, or a video machine wherein selected symbols are displayed on virtual reels on a graphical display device.

However, while such gaming systems provide users with enjoyment, a need exists for alternative gaming systems in order to maintain or increase player enjoyment.

### BRIEF SUMMARY OF THE INVENTION

In accordance with a first aspect of the present invention, there is provided a gaming system comprising:

a display device arranged to display symbols from a plurality of sets of symbols at a plurality of display positions, each of the display positions including a symbol associated with each of the sets of symbols;

a symbol set selector arranged to facilitate selection by a player of one of the sets of symbols to be used for determining a game outcome;

a symbol selector arranged to select symbols for display at the display positions; and

an outcome generator arranged to determine a game outcome based on symbols from the selected symbol set displayed at the display positions.

In one embodiment, the sets of symbols have different characteristics.

In one embodiment, the characteristics comprise different associated volatilities and/or player returns.

In one embodiment, the characteristics comprise different associated sounds.

In one arrangement, the symbol set selector is arranged to facilitate selection by a user of one of the sets of symbols to be used for determining a game outcome before the symbol selector selects symbols for display at the display positions.

In an alternative arrangement, the symbol set selector is arranged to facilitate selection by a user of one of the sets of symbols to be used for determining a game outcome after the symbol selector selects symbols for display at the display positions.

In one embodiment, each display position includes a symbol from each set which is different to a symbol from the or each other set.

In one embodiment, at least one display position includes a symbol common to all symbols sets.

The display may be arranged to display graphical representations of a plurality of reels, each reel including a plurality of associated symbols.

The gaming system may be arranged such that the display positions are disposed in a plurality of reels and at least one reel includes a symbol common to all symbol sets at each display position on the reel. In one embodiment, a plurality of reels each include a symbol common to all symbol sets at each display position on the reel.

In one embodiment, symbols from the selected symbol set displayed at the display positions are emphasized relative to symbols from the symbol set displayed at the display positions which have not been selected.

Selected symbols may be emphasized by enlarging selected symbols relative to symbols which have not been selected, by increasing the intensity of selected symbols relative to symbols which have not been selected, by reducing the visibility of symbols which have not been selected relative to selected symbols, by displaying selected symbols in color and symbols which have not been selected in black and white, or in any other way.

In one arrangement, 2, 3 or 4 symbol sets are provided.

At least one set of symbols may include at least one function symbol having an associated function which may be a wild function, a scatter function, a multiplier function, a repeat win function or a jackpot function.

In one embodiment, the gaming system is arranged to operate in normal game mode and special game mode, and the symbol set selector is arranged to facilitate selection by a user of one of the sets of symbols only when the gaming system operates in special game mode.

The gaming system may be arranged to commence special game mode when a predetermined game outcome occurs, on the basis of a game event occurring during a game such as display of a particular symbol, in response to player input, based on the amount or type of bet placed, or when a special game is purchased by a player.

The gaming system may be implemented as a stand alone gaming machine or across a network.

In accordance with a second aspect of the present invention, there is provided a method of gaming comprising:

displaying symbols from a plurality of sets of symbols at a plurality of display positions, each of the display positions including a symbol associated with each of the sets of symbols;

facilitating selection by a user of one of the sets of symbols to be used for determining a game outcome;

selecting symbols for display at the display positions; and

determining a game outcome based on symbols from the selected symbol set displayed at the display positions.

In accordance with a third aspect of the present invention, there is provided a computer program arranged when loaded into a computer to instruct the computer to operate in accordance with a gaming system comprising:

a display device arranged to display symbols from a plurality of sets of symbols at a plurality of display positions, each of the display positions including a symbol associated with each of the sets of symbols;

a symbol set selector arranged to facilitate selection by a user of one of the sets of symbols to be used for determining a game outcome;

a symbol selector arranged to select symbols for display at the display positions; and

an outcome generator arranged to determine a game outcome based on symbols from the selected symbol set displayed at the display positions.

In accordance with a fourth aspect of the present invention, there is provided a computer readable medium having computer readable program code embodied therein for causing a computer to operate in accordance with a gaming system comprising:

a display device arranged to display symbols from a plurality of sets of symbols at a plurality of display positions, each of the display positions including a symbol associated with each of the sets of symbols;

a symbol set selector arranged to facilitate selection by a user of one of the sets of symbols to be used for determining a game outcome;

a symbol selector arranged to select symbols for display at the display positions; and

an outcome generator arranged to determine a game outcome based on symbols from the selected symbol set displayed at the display positions.

In accordance with a fifth aspect of the present invention, there is provided a data signal having computer readable program code embodied therein for causing a computer to operate in accordance with a gaming system comprising:

a display device arranged to display symbols from a plurality of sets of symbols at a plurality of display positions, each of the display positions including a symbol associated with each of the sets of symbols;

a symbol set selector arranged to facilitate selection by a user of one of the sets of symbols to be used for determining a game outcome;

a symbol selector arranged to select symbols for display at the display positions; and

an outcome generator arranged to determine a game outcome based on symbols from the selected symbol set displayed at the display positions.

### BRIEF DESCRIPTION OF SEVERAL VIEWS OF THE DRAWINGS

The present invention will now be described, by way of example only, with reference to the accompanying drawings, in which:

FIG. 1 is a schematic block diagram of core components of a gaming system in accordance with an embodiment of the present invention;

FIG. 2 is a schematic block diagram of functional components of a gaming system in accordance with an embodiment of the present invention;

FIG. 3 is a diagrammatic representation of a gaming system in accordance with an embodiment of the present invention with the gaming system implemented in the form of a stand alone gaming machine;

FIG. 4 is a schematic block diagram of operative components of the gaming machine shown in FIG. 3;

FIG. 5 is a schematic block diagram of components of a memory of the gaming machine shown in FIG. 3;

FIG. 6 is a schematic diagram of a gaming system in accordance with an alternative embodiment of the present invention with the gaming system implemented over a network;

FIG. 7 is a flow diagram illustrating game play of a gaming system in accordance with an embodiment of the present invention; and

FIG. 8 is a diagrammatic representation of example displayed symbols of a gaming system in accordance with an embodiment of the present invention during implementation of a game;

FIGS. 9a and 9b are diagrammatic representations of example display locations when a first set of symbols or a second set of symbols respectively are selected;

FIG. 10 is a diagrammatic representation of example displayed symbols after selection of a first set of symbols by a player;

FIG. 11 is a diagrammatic representation of example displayed symbols after selection of a second set of symbols by a player; and

FIG. 12 is a diagrammatic representation of an example display location when four sets of symbols are associated with the display location and a first set of symbols has been selected.

### DETAILED DESCRIPTION OF THE INVENTION

Referring to the drawings, there is shown a schematic block diagram of a gaming system 10 arranged to implement a probabilistic game of the type wherein several symbols from a set of symbols are randomly displayed, and a game outcome is determined on the basis of the displayed symbols. With some such probabilistic games, the set of symbols include standard symbols and function symbols, and the game outcome is determined on the basis of the displayed standard symbols and the function associated with any displayed function symbol. For example, standard symbols may resemble fruit such as apples, pears and bananas with a win outcome being determined when a predetermined number of the same fruit appear on a display in the same line, scattered, and so on. The function associated with a function symbol may be for example a wild function wherein display of the function symbol is treated during consideration of the game outcome as any of the standard symbols. A function symbol may be represented as the word “WILD”, a star, or by any other suitable word or symbol. Other functions are also envisaged such as scatter functions, multiplier functions, repeat win functions, jackpot functions and feature commencement functions. The game may also be arranged such that under particular circumstances, one or more standard symbols acquire one or more functions.

The present gaming system operates such that a plurality of sets of symbols are associated with the gaming system and at least during a portion of a game implemented by the gaming system, a player is able to select the set of symbols that are desired to be used in determining a game outcome.

The different sets of symbols available for selection may have different characteristics, including different play returns and/or volatilities and, in this way, a player is able to make a choice as to whether, for example, a relatively high possible payout but low probability of success game or a relatively low payout but relatively high probability of success game will be played.

In addition, or alternatively, the different sets of symbols may have different types of associated sounds.

The option for a player to select a desired symbol set to form the basis of determining game outcomes may be available for all games, only under special game conditions such as during free games or when a player has placed a specific bet entitling the player to select a suitable set, or when a system event or player marketing module enables a special game condition.

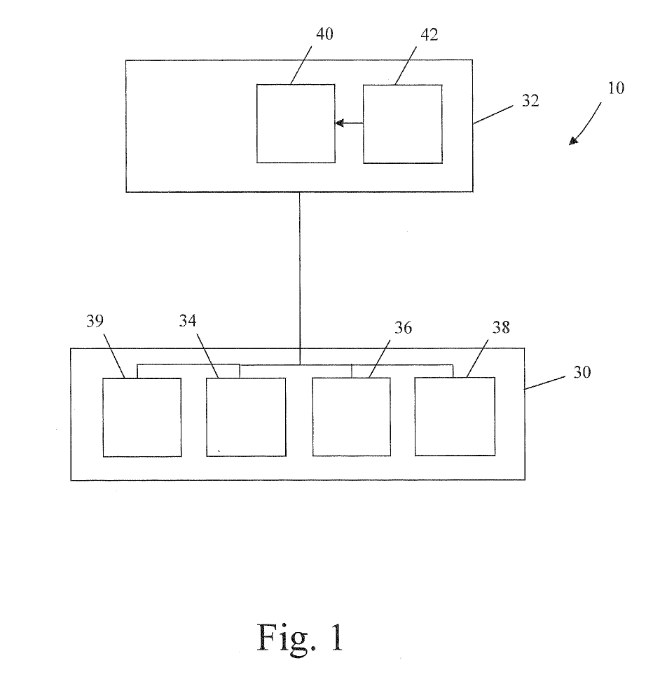

Referring to FIG. 1, a schematic diagram of core components of a gaming system 10 is shown. The core components comprise a player interface 30 and a game controller 32. The player interface 30 is arranged to enable interaction between a player and the gaming system and for this purpose includes input/output components required for the player to enter instructions and play the game.

Components of the player interface 30 may vary but will typically include a credit mechanism 34 to enable a player to input credits and receive payouts, one or more displays 36 which may comprise a touch screen, a game play mechanism 38 arranged to enable a player to input game playing instructions, and speakers 39.

The game controller 32 is in data communication with the player interface 30 and typically includes a processor 40 arranged to process game play instructions and output game player outcomes to the display 36. Typically, the game play instructions are stored as program code in a memory 42 that can also be hardwired. It will be understood that in this specification the term “processor” is used to refer generically to any device that can process game play instructions and may include a microprocessor, microcontroller, programmable logic device or other computational device such as a personal computer or a server.

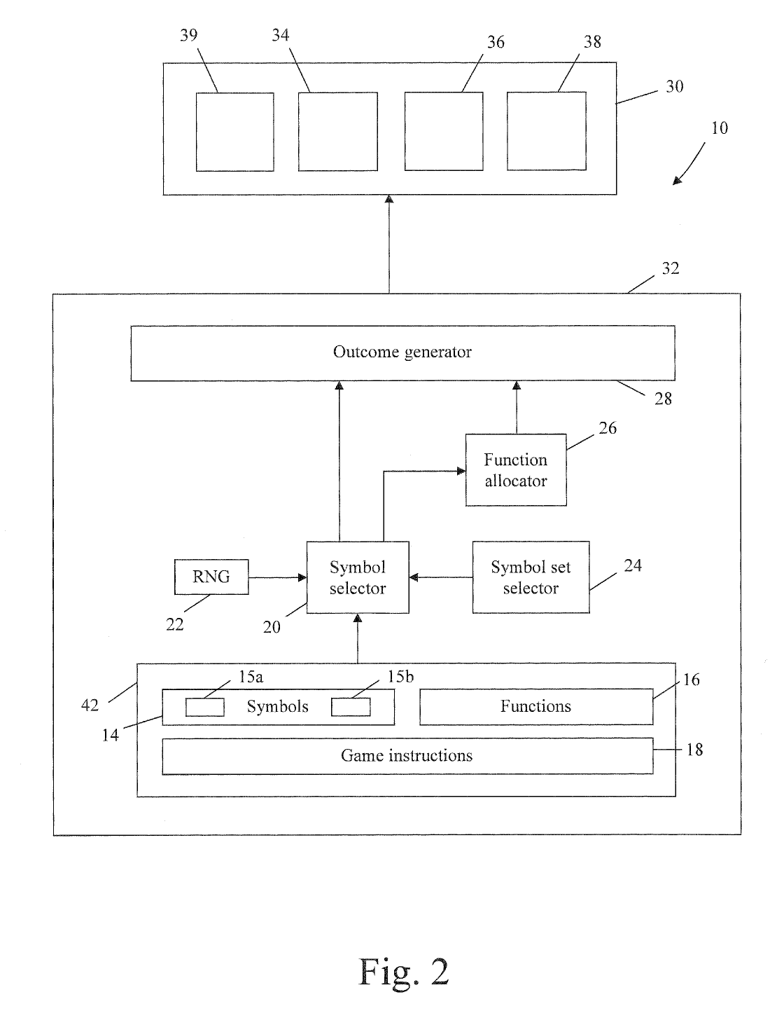

A functional diagram illustrating operative components of the game controller 32 is shown in FIG. 2.

The memory 42 is arranged to store symbols data 14 indicative of a plurality of sets 15a, 15b of symbols for display to a player, function data 16 indicative of one or more functions allocatable to the symbols, and game instruction data 18 indicative of game instructions usable by the gaming machine 10 to control operation of the game.

The game controller 32 includes a symbol selector 20 which is arranged to select several symbols from the available symbols 14 for display to a player in a plurality of display positions, each display position including one symbol associated with each of the suitable sets 15a, 15b of symbols. In this example, the selection carried out by the symbol selector 20 is made using a random number generator 22.

It will be appreciated that the random number generator 22 may be of a type which is arranged to generate pseudo random numbers based on a seed number, and that in this specification the term “random” will be understood accordingly to mean truly random or pseudo random.

In this example, each symbol in a first symbol set 15a is paired with a symbol in a second symbol set 15b, and when selected by the symbol selector 20, the paired symbols are both displayed at a display position. However, other variations are possible. For example, at least one symbol may be common to both first and second symbol sets 15a, 15b such that for at least one display position only one symbol is displayed.

The game controller 32 also comprises a symbol set selector 24 arranged to facilitate selection by a player of one of the symbol sets 15a, 15b to be used in determining game outcomes.

In this example, the game controller 32 also comprises a function allocator 26 arranged to select and allocate one or more functions to one or more symbols. Such functions include a wild function, a scatter function, or any other function which may be applied to a symbol or to the game.

The game controller 32 also comprises an outcome generator 28 which in accordance with the game instructions 18 determines game outcomes based on the symbol set selected by a player, and on the symbols from the selected symbol set selected for display to the player by the symbol selector 20.

In the embodiments described below, the symbol selector 20, the symbol set selector 24, the function allocator 26, and the outcome generator 28 are at least partly implemented using the processor 40 and associated software, although it will be understood that other implementations are envisaged.

The gaming system 10 can take a number of different forms.

In a first form, a stand alone gaming machine is provided wherein all or most components required for implementing the game are present in a player operable gaming machine.

In a second form, a distributed architecture is provided wherein some of the components required for implementing the game are present in a player operable gaming machine and some of the components required for implementing the game are located remotely relative to the gaming machine. For example, a “thick client” architecture may be used wherein part of the game is executed on a player operable gaming machine and part of the game is executed remotely, such as by a gaming server; or a “thin client” architecture may be used wherein most of the game is executed remotely such as by a gaming server and a player operable gaming machine is used only to display audible and/or visible gaming information to the player and receive gaming inputs from the player.

However, it will be understood that other arrangements are envisaged. For example, an architecture may be provided wherein a gaming machine is networked to a gaming server and the respective functions of the gaming machine and the gaming server are selectively modifiable. For example, the gaming system may operate in stand alone gaming machine mode, “thick client” mode or “thin client”mode depending on the game being played, operating conditions, and so on. Other variations will be apparent to persons skilled in the art.

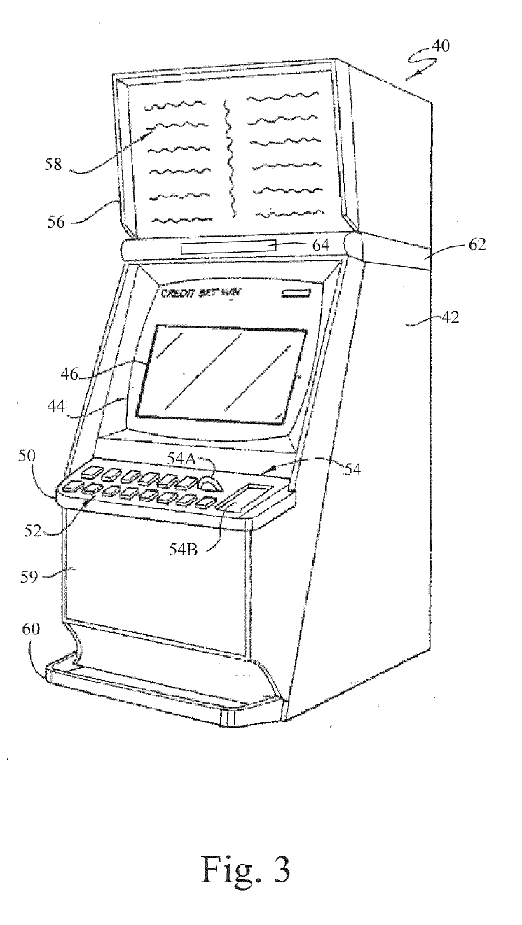

A gaming system in the form of a stand alone gaming machine 40 is illustrated in FIG. 3. The gaming machine 40 includes a console 42 having a display 44 on which is displayed representations of a game 46 that can be played by a player. A mid-trim 50 of the gaming machine 40 houses a bank of buttons 52 for enabling a player to interact with the gaming machine, in particular during gameplay. The mid-trim 50 also houses a credit input mechanism 54 which in this example includes a coin input chute 54A and a bill collector 54B. Other credit input mechanisms may also be employed, for example, a card reader for reading a smart card, debit card or credit card.

A top box 56 may carry artwork 58, including for example pay tables and details of bonus awards and other information or images relating to the game. Further artwork and/or information may be provided on a front panel 59 of the console 42. A coin tray 60 is mounted beneath the front panel 59 for dispensing cash payouts from the gaming machine 40.

The display 44 is in the form of a video display unit, particularly a cathode ray tube screen device. Alternatively, the display 44 may be a liquid crystal display, plasma screen, or any other suitable video display unit. The top box 56 may also include a display, for example a video display unit, which may be of the same type as the display 44, or of a different type. The display 44 may comprise a touch screen usable by a player to interact with the gaming machine, in particular during game play.

The buttons 52 and/or a touch screen incorporated into the display 44 may be used by a player during game play to select one of a plurality of sets of symbols which are to be used to determine game outcomes.

The display 44 in this example is arranged to display representations of several reels, each reel of which has several associated symbols. Typically 3, 4 or 5 reels are provided. During operation of the game, the reels first appear to rotate then stop with typically three symbols visible on each reel. Game outcomes are determined on the basis of the visible symbols together with any special functions associated with the symbols.

A player marketing module (PMM) 62 having a display 64 is connected to the gaming machine 10. The main purpose of the PMM 62 is to allow the player to interact with a player loyalty system. The PMM has a magnetic card reader for the purpose of reading a player tracking device, for example as part of a loyalty program. However other reading devices may be employed and the player tracking device may be in the form of a card, flash drive or any other portable storage medium capable of being read by the reading device. In this example, the PMM 62 is a Sentinel III device produced by Aristocrat Technologies Pty Ltd.

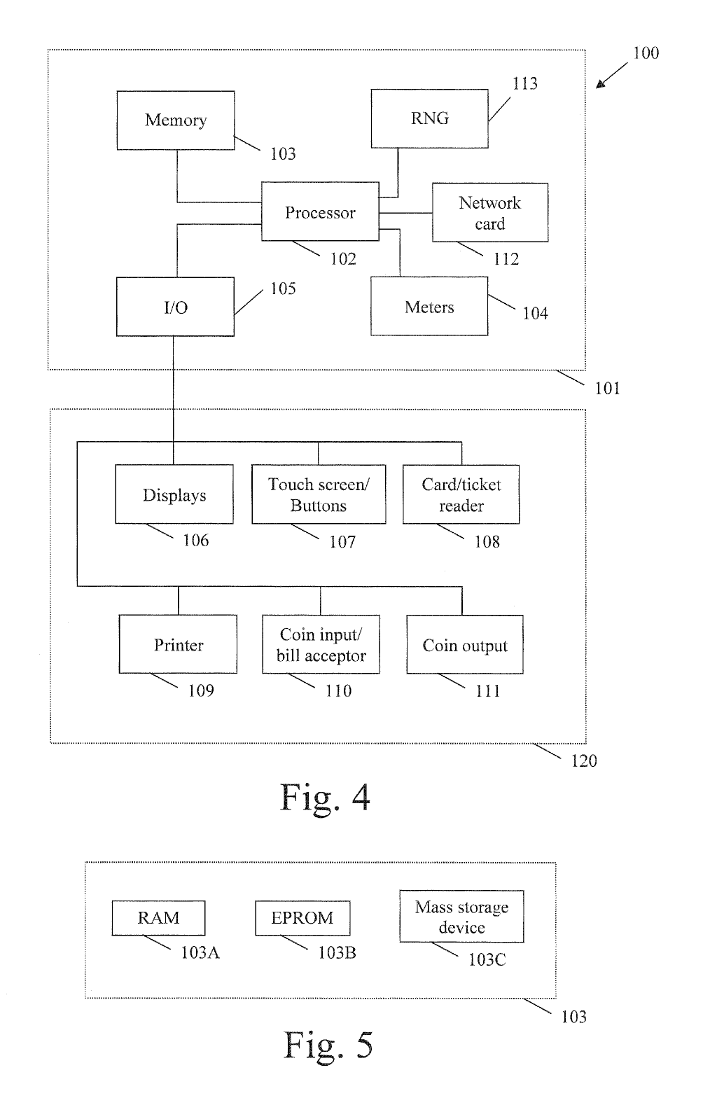

FIG. 4 shows a block diagram of operative components of a gaming machine 100 which may be the same as or different to the gaming machine shown in FIG. 3.

The gaming machine 100 includes a game controller 101 having a processor 102. Instructions and data to control operation of the processor 102 in accordance with the present invention are stored in a memory 103 which is in data communication with the processor 102.

Typically, the gaming machine 100 will include both volatile and non-volatile memory and more than one of each type of memory, with such memories being collectively represented by the memory 103.

FIG. 5 shows a block diagram of the main components of an exemplary memory 103. The memory 103 includes RAM 103A, EPROM 103B and a mass storage device 103C. The RAM 103A typically temporarily holds program files for execution by the processor 102 and related data. The EPROM 103B may be a boot ROM device and/or may contain some system or game related code. The mass storage device 103C is typically used to store game programs, the integrity of which may be verified and/or authenticated by the processor 102 using protected code from the EPROM 103B or elsewhere.

The gaming machine has hardware meters 104 for purposes including ensuring regulatory compliance and monitoring player credit, an input/output (I/O) interface 105 for communicating with a player interface 120 of the gaming machine 100, the player interface 120 having several peripheral devices. The input/output interface 105 and/or the peripheral devices may be intelligent devices with their own memory for storing associated instructions and data for use with the input/output interface or the peripheral devices. A random number generator module 113 generates random numbers for use by the processor 102.

In the example shown in FIG. 4, the peripheral devices that communicate with the game controller 101 comprise one or more displays 106, a touch screen and/or bank of buttons 107, a card and/or ticket reader 108, a printer 109, a bill acceptor and/or coin input mechanism 110 and a coin output mechanism 111. Additional hardware may be included as part of the gaming machine 100, or hardware may be omitted as required for the specific implementation.

In addition, the gaming machine 100 may include a communications interface, for example a network card 112. The network card may, for example, send status information, accounting information or other information to a central controller, server or database and receive data or commands from the central controller, server or database.

It is also possible for the operative components of the gaming machine 100 to be distributed, for example input/output devices 106, 107, 108, 109, 110, 111 may be provided remotely from the game controller 101.

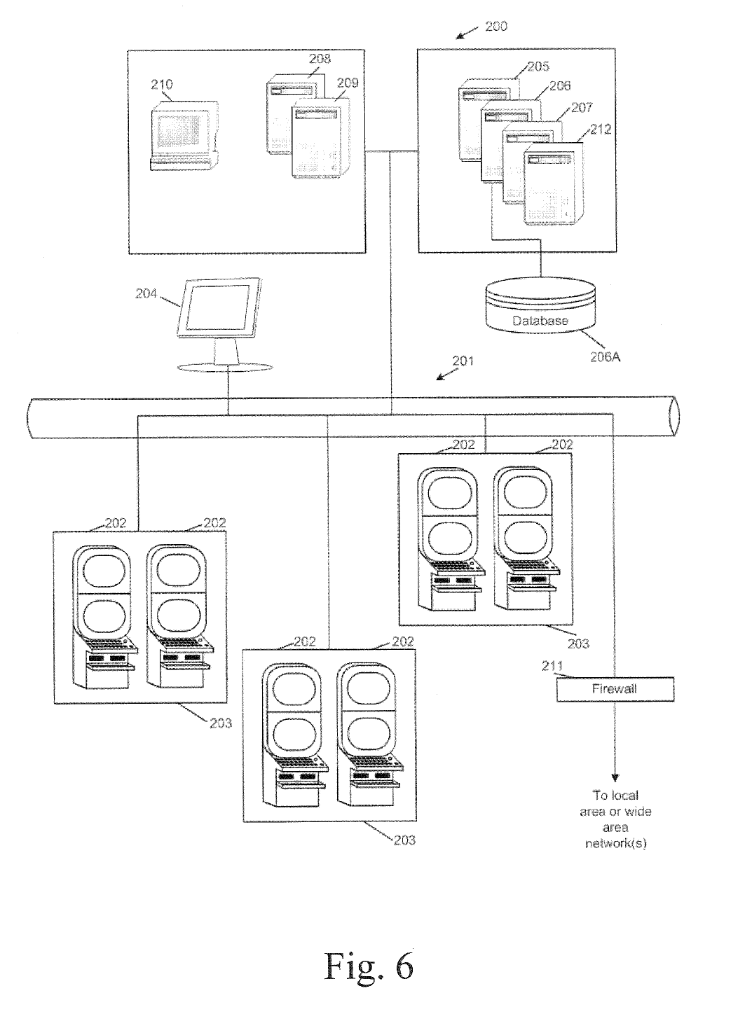

FIG. 6 shows a gaming system 200 in accordance with an alternative embodiment. The gaming system 200 includes a network 201, which for example may be an Ethernet network, a LAN or a WAN. In this example, three banks 203 of two gaming machines 202 are connected to the network 201. The gaming machines 202 provide a player operable interface and may be the same as the gaming machines 40, 100 shown in FIGS. 3 and 4, or may have simplified functionality depending on the requirements for implementing game play. While banks 203 of two gaming machines are illustrated in FIG. 6, banks of one, three or more gaming machines are also envisaged.

One or more displays 204 may also be connected to the network 201. The displays 204 may, for example, be associated with one or more banks 203 of gaming machines. The displays 204 may be used to display representations associated with game play on the gaming machines 202, and/or used to display other representations, for example promotional or informational material.

In a thick client embodiment, a game server 205 implements part of the game played by a player using a gaming machine 202 and the gaming machine 202 implements part of the game. With this embodiment, as both the game server 205 and the gaming machine 202 implement part of the game, they collectively provide a game controller. A database management server 206 may manage storage of game programs and associated data for downloading or access by the gaming devices 202 in a database 206A. Typically, if the gaming system enables players to participate in a Jackpot game, a Jackpot server 207 will be provided.

In a variation of the above thick client embodiment, the gaming machine 202 may implement the game, with the game server 205 functioning merely to serve data indicative of a game to the gaming machine 202 for implementation.

With this implementation, a data signal containing a computer program usable by the client terminal to implement the gaming system may be transferred from the game server to the client terminal, for example in response to a request by the client terminal.

In a thin client embodiment, the game server 205 implements most or all of the game played by a player using a gaming machine 202 and the gaming machine 202 essentially provides only the player interface. With this embodiment, the game server 205 provides the game controller. The gaming machine will receive player instructions, and pass the instructions to the game server which will process them and return game play outcomes to the gaming machine for display. In a thin client embodiment, the gaming machines could be computer terminals, e.g. PCs running software that provides a player interface operable using standard computer input and output components.

Servers are also typically provided to assist in the administration of the gaming system 200, including for example a gaming floor management server 208 and a licensing server 209 to monitor the use of licenses relating to particular games. An administrator terminal 210 is provided to allow an administrator to monitor the network 201 and the devices connected to the network.

The gaming system 200 may communicate with other gaming systems, other local networks such as a corporate network, and/or a wide area network such as the Internet, for example through a firewall 211.

A loyalty program server 212 may also be provided.

Persons skilled in the art will appreciate that in accordance with known techniques, functionality at the server side of the network may be distributed over a plurality of different computers. For example, elements may be run as a single “engine” on one server or a separate server may be provided. For example, the game server 205 could run a random number generator engine. Alternatively, a separate random number generator server could be provided.

During operation, the game controller, whether implemented in a stand alone gaming machine 10, 40, 100 or over a network 201, implements a probabilistic game wherein at least during part of the game the gaming system displays to a player symbols forming part of a plurality of sets of symbols at a plurality of display positions, and facilitates selection by a player of one of the symbol sets which are desired to be used to determine game outcomes.

Examples of specific implementations of the gaming system will now be described in relation to a stand alone gaming machine 10, 40, 100 although it will be understood that implementation may also be carried out using other gaming system architectures such as a network architecture of the type shown in FIG. 6.

In one embodiment, selection by a player of a symbol set to be used in determining game outcomes is always available to a player. The selection of a symbol set may occur prior to selection of the symbols to be displayed at the available display positions by the symbol selector 20, or after selection of the displayed symbols.

Selection of a symbol set may be made for example using the buttons 52 or the touch screen 107.

In an alternative embodiment, the gaming system is operable in normal game mode and special game mode.

During normal game mode, selection of a symbol set does not occur and one of the sets of symbols is automatically used by the gaming system to determine game outcomes. In an example comprising a plurality of reels, the reels comprise standard symbols and optionally one or more function symbols. Win outcomes are determined on the basis of the symbols from the automatically selected symbol set visible when the reels stop rotating.

During special game mode, the reels display all sets of symbols and a player is provided with the option of selecting one set of symbols to be used to determine a game outcome.

The gaming system may be arranged to commence special game mode when a predetermined game outcome occurs, and special game mode may comprise one or more free games, in this example three free games. Special game mode may commence automatically on the basis of a game event occurring during a game such as display of a particular symbol, based on game outcomes determined by the gaming system, or may be prompted by a player pressing a button on the gaming system 10, 40, 100 after the player has identified that a game outcome corresponding to special game mode requirements has occurred.

The gaming system 10, 40, 100 may also be arranged so as to determine eligibility for special game mode, for example based on the amount or type of bet placed, based on certain time periods and so on.

Special game mode may also be arranged to commence when a special game is purchased by a player either using available credits or through a player marketing module.

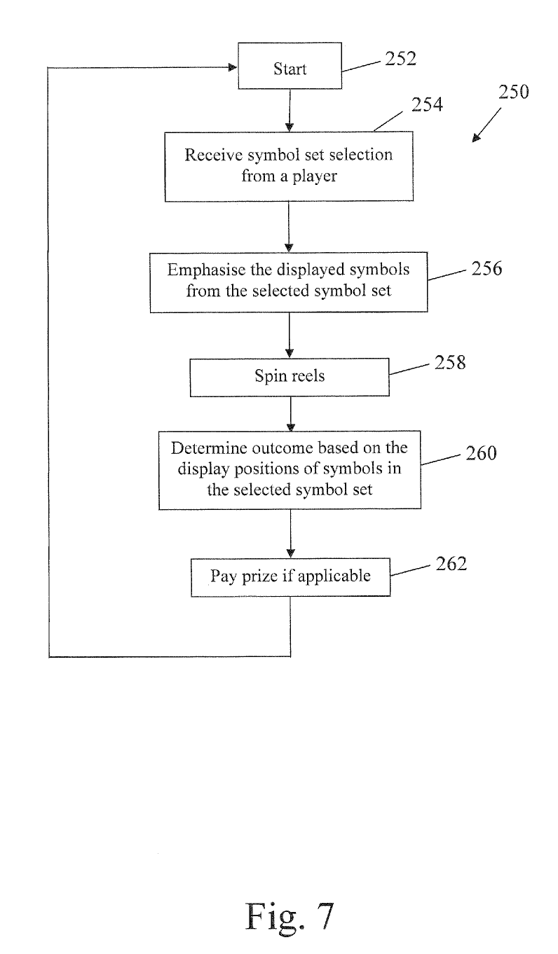

A specific example will now be described in relation to flow diagram 250 shown in FIG. 7 which illustrates steps 252 to 262 of a method of gaming implemented by the gaming system according to the present embodiment.

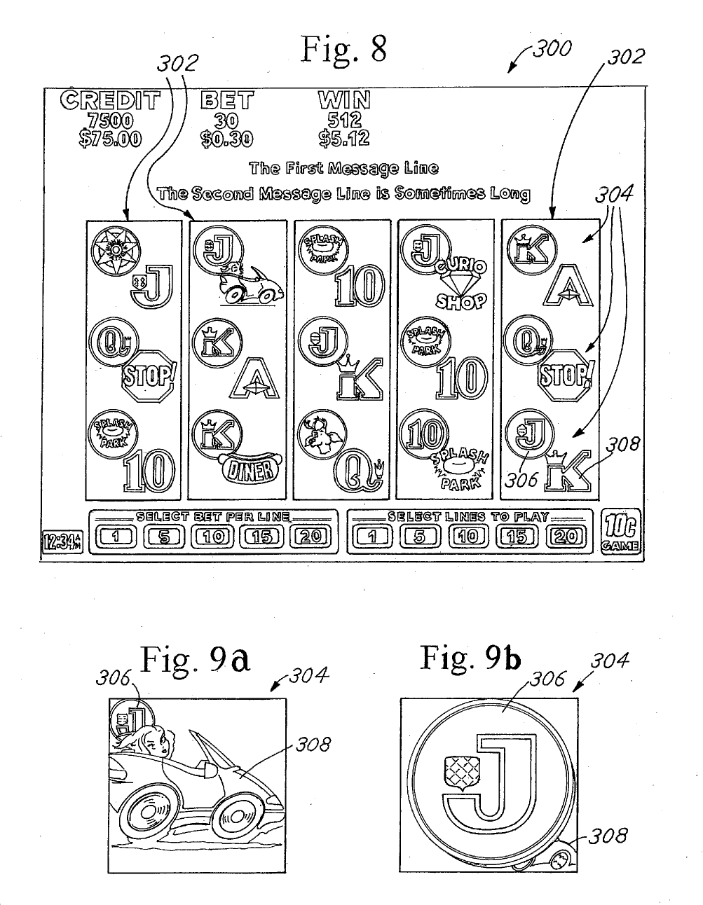

In this example, five reels are provided. The reels are virtual reels and, as such, representations of the reels are displayed on a graphical display device 44. An example screen representation 300 shown on the display device 44 is shown in FIG. 8.

As shown in FIG. 8, the display representation 300 includes five virtual reels 302, each of which includes three display positions 304. At each display position 304 a first symbol 306 from a first set of symbols and a second symbol 308 from a second set of symbols is displayed.

In this example, a player selects 254 one of the first and second sets of symbols to be used in determining game outcomes prior to spinning of the reels 302 and selection by the symbol selector 20 of symbols to be displayed at the display positions 304. In this example, a symbol set is selected by touching the display at one of the first 306 or second 308 symbols. However, other arrangements are envisaged. For example, a user may select the first or second set of symbols using an appropriate button on a gaming machine 40.

When the first or second set of symbols is selected, the selected set of symbols is emphasized 256 relative to the symbol set which has not been selected. Emphasis of a selected symbol set may occur in any suitable way. For example, as shown in FIGS. 9a and 9b, symbols from a selected symbol set may enlarge relative to the symbol set which has not been selected. However, other implementations are envisaged such as increasing the intensity of the selected symbol set, reducing the visibility of the symbol set which has not been selected, representing the symbol set which has not been selected in black and white whilst maintaining the selected symbol set in colour, and so on.

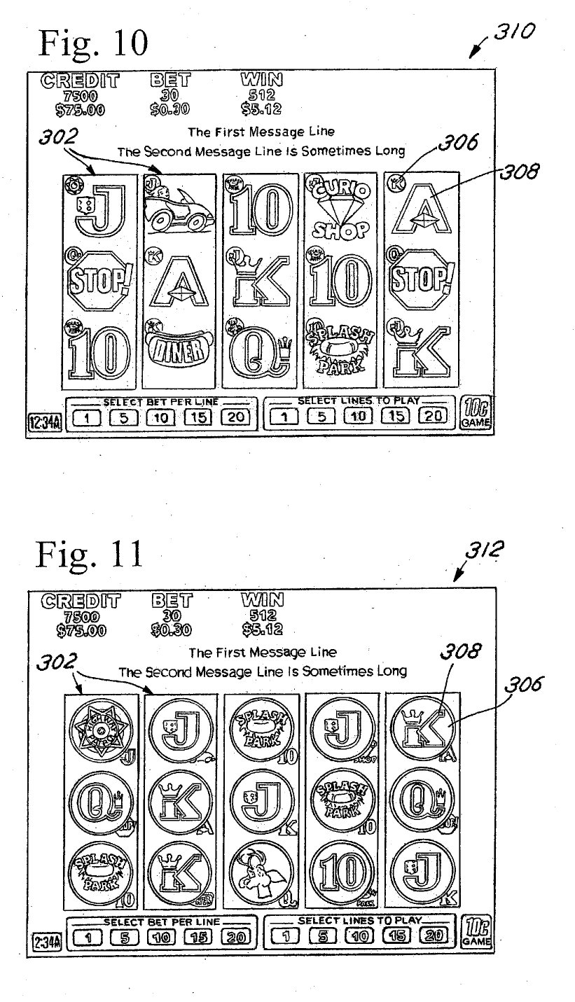

A display representation 310 showing the display positions after selection of a first symbol set is shown in FIG. 10. A display representation 312 showing display positions after selection of a second symbol set is shown in FIG. 11.

After a symbol set has been selected by a player, the symbol selector 20 selects symbols 258 from the first and second sets to be displayed in the display positions 304 with the symbols from the selected symbol set being enlarged relative to the symbol set which has not been selected, and the outcome generator 28 evaluates the displayed symbols to determine the game outcome 260. In the event that the displayed symbols from the selected symbol set corresponds to a win outcome, the player is awarded a prize 262.

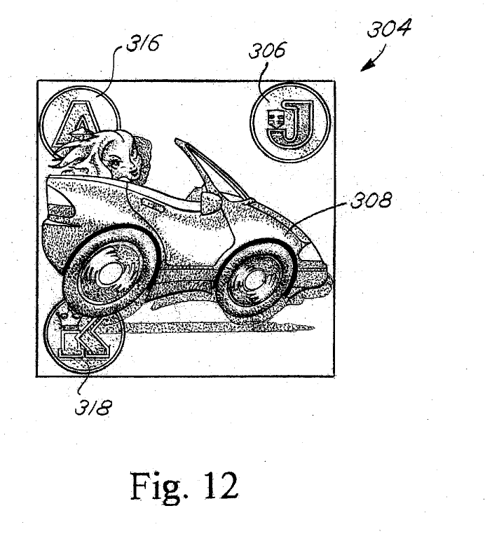

While the above embodiment is described in relation to two symbol sets, it will be understood that other variations are possible. For example, as shown in FIG. 12, each display position 304 may include first, second, third and fourth symbols 306, 308, 316, 318 respectively derived from first, second, third and fourth symbol sets.

While the above examples are described in relation to symbol sets wherein a first symbol from a first symbol set is different to and paired with a second symbol from a second symbol set such that two symbols are always displayed at each of the display positions 304, it will be understood that other arrangements are possible. For example, at least one symbol may be common to both first and second symbol sets such that at least one display position may include one symbol instead of two symbols. In a variation on this embodiment, the arrangement may be such that a common symbol is provided for all symbols in one or more of the reels 302, and for at least one reel 302 two symbols are provided at each display position.

In a further variation, for at least some games implemented by the gaming system, both sets of symbols may be used in determining game outcomes. This may occur during a special game mode, when a player has placed an additional bet, and so on.

While the above examples are described in relation to a gaming system comprising virtual spinning reels provided with symbols, it will be understood that the invention is applicable to other gaming systems wherein symbols are randomly displayed and the display positions of the symbols has an effect on the game outcome. For example, the invention may be applied to a gaming system arranged to implement a card style game.

In the claims of this application and in the description of the invention, except where the context requires otherwise due to express language or necessary implication, the words “comprise” or variations such as “comprises” or “comprising” are used in an inclusive sense, i.e. to specify the presence of the stated features but not to preclude the presence or addition of further features in various embodiments of the invention.

Modifications and variations as would be apparent to a skilled addressee are deemed to be within the scope of the present invention.

1. A gaming system comprising:
a display device arranged to display symbols from a plurality of sets of symbols at a plurality of display positions, each of the display positions including a symbol associated with each of the sets of symbols;
a symbol set selector arranged to facilitate selection by a player of one of the sets of symbols to be used for determining a game outcome;
a symbol selector arranged to select symbols for display at the display positions; and
an outcome generator arranged to determine a game outcome based on symbols from the selected symbol set displayed at the display positions.

2. A gaming system as claimed in claim 1, wherein the sets of symbols have different characteristics.

3. A gaming system as claimed in claim 2, wherein the characteristics comprise different associated volatilities and/or player returns.

4. A gaming system as claimed in claim 2, wherein the characteristics comprise different associated sounds.

5. A gaming system as claimed in claim 1, wherein the symbol set selector is arranged to facilitate selection by a user of one of the sets of symbols to be used for determining a game outcome before the symbol selector selects symbols for display at the display positions.

6. A gaming system as claimed in claim 1, wherein the symbol set selector is arranged to facilitate selection by a user of one of the sets of symbols to be used for determining a game outcome after the symbol selector selects symbols for display at the display positions.

7. A gaming system as claimed in claim 1, wherein the symbol set selector is arranged to facilitate selection by a user of one of the sets of symbols by touching one symbol associated with a symbol set on the display device.

8. A gaming system as claimed in claim 1, wherein each display position includes a symbol from each set which is different to a symbol from the or each other set.

9. A gaming system as claimed in claim 1, wherein at least one display position includes a symbol common to all symbols sets.

10. A gaming system as claimed in claim 9, wherein the gaming system is arranged such that the display positions are disposed in a plurality of reels and at least one reel includes a symbol common to all symbol sets at each display position on the reel.

11. A gaming system as claimed in claim 10, wherein a plurality of reels each include a symbol common to all symbol sets at each display position on the reel.

12. A gaming system as claimed in claim 1, wherein symbols from a selected symbol set displayed at the display positions are emphasized relative to symbols from each symbol set displayed at the display positions which have not been selected.

13. A gaming system as claimed in claim 12, wherein selected symbols are emphasized by enlarging selected symbols relative to symbols which have not been selected.

14. A gaming system as claimed in claim 12, wherein selected symbols are emphasized by increasing the intensity of selected symbols relative to symbols which have not been selected.

15. A gaming system as claimed in claim 12, wherein selected symbols are emphasized by reducing the visibility of symbols which have not been selected relative to selected symbols.

16. A gaming system as claimed in claim 12, wherein selected symbols are emphasized by displaying selected symbols in color and symbols which have not been selected in black and white.

17. A gaming system as claimed in claim 1, wherein 2, 3 or 4 symbol sets are provided.

18. A gaming system as claimed in claim 1, wherein the gaming system is arranged to operate in normal game mode and special game mode, and the symbol set selector is arranged to facilitate selection by a user of one of the sets of symbols only when the gaming system operates in special game mode.

19. A gaming system as claimed in claim 1, wherein the gaming system is implemented as a stand alone gaming machine or across a network.

20. A method of gaming comprising:
displaying symbols from a plurality of sets of symbols at a plurality of display positions, each of the display positions including a symbol associated with each of the sets of symbols;
receiving selection by a user of one of the sets of symbols to be used for determining a game outcome;
selecting symbols for display at the display positions; and
determining a game outcome based on symbols from the selected symbol set displayed at the display positions.

21. A method as claimed in claim 20, comprising providing the sets of symbols with different characteristics.

22. A method as claimed in claim 21, wherein the characteristics are different associated volatilities and/or player returns.

23. A method as claimed in claim 20, comprising receiving selection by a user of one of the sets of symbols to be used for determining a game outcome before the symbol selector selects symbols for display at the display positions.

24. A method as claimed in claim 20, comprising receiving selection by a user of one of the sets of symbols to be used for determining a game outcome after the symbol selector selects symbols for display at the display positions.

25. A method as claimed in claim 20, comprising receiving selection by a user of one of the sets of symbols by touching one symbol associated with a symbol set on the display device.

26. A method as claimed in claim 20, comprising providing each display position with a symbol from each set which is different to a symbol from the or each other set.

27. A method as claimed in claim 20, comprising providing at least one display position with a symbol common to all symbols sets.

28. A method as claimed in claim 27, comprising disposing the display positions in a plurality of reels with at least one reel including a symbol common to all symbol sets at each display position on the reel.

29. A method as claimed in claim 28, comprising providing a plurality of reels each including a symbol common to all symbol sets at each display position on the reel.

30. A method as claimed in claim 20, comprising emphasizing symbols from a selected symbol set relative to symbols from the or each symbol set which has not been selected.

31. A method as claimed in claim 30, comprising emphasizing selected symbols by enlarging selected symbols relative to symbols which have not been selected.

32. A method as claimed in claim 30, comprising emphasizing selected symbols by increasing the intensity of selected symbols relative to symbols which have not been selected.

33. A method as claimed in claim 30, comprising emphasizing selected symbols by reducing the visibility of symbols which have not been selected relative to selected symbols.

34. A method as claimed in claim 30, comprising emphasizing selected symbols by displaying selected symbols in color and symbols which have not been selected in black and white.

35. A method as claimed in claim 20, wherein 2, 3 or 4 symbol sets are provided.

36. A computer program arranged when loaded into a computer to instruct the computer to operate in accordance with a gaming system as claimed in claim 1.

37. A computer readable medium having computer readable program code embodied therein for causing a computer to operate in accordance with a gaming system as claimed in claim 1.

38. A data signal having computer readable program code embodied therein for causing a computer to operate in accordance with a gaming system as claimed in claim 1.

39. A gaming system substantially as hereinbefore described with reference to, and as shown in, the accompanying drawings.

40. A method of gaming substantially as hereinbefore described with reference to, and as shown in, the accompanying drawings.
